(19) United States
(12) Patent Application Publication
(10) Pub. No.: US 2025/0282964 A1
(43) Pub. Date: Sep. 11, 2025

(54) Decoating solution, process, and device for wet chemical removal of a PVD or CVD titanium nitride layer from a hard-metal substrate

(71) Applicant: Betek GmbH & Co. KG, Aichhalden (DE)

(72) Inventors: Joachim Penalver, Aichhalden (DE); Claus Penalver, Alpirsbach (DE); Tobias Hilgert, Schramberg (DE)

(21) Appl. No.: 18/862,197

(22) PCT Filed: Apr. 3, 2023
(86) PCT No.: PCT/EP2023/058689

§ 371 Date: Nov. 1, 2024

(30) Foreign Application Priority Data
Jun. 2, 2022 (DE) 10 2022 113 998.0

(51) Int. Cl. C09D 9/00; B08B 3/06; B08B 3/08

(52) U.S. Cl. CPC C09D 9/00; B08B 3/06; B08B 3/08

(57) ABSTRACT

The invention relates to a decoating solution (14), a process (41) and a device (10) for the wet-chemical removal of a PVD or CVD titanium nitride layer from a hard-metal substrate by means of such a solution (14). Proposition is made for the decoating solution (14) to consist of:

70-85 wt % of water,

1-10 wt % of a hydrogen compound that is not water (e.g., hydrogen peroxide) and

10-20 wt % of an ammonium salt (e.g., ammonium bifluoride),

wherein the decoating solution (14) has a pH of less than 7, preferably less than 5, at room temperature. In addition, a proportion of 1-3 wt % of a carboxylic acid (e.g., citric acid) can be added to the solution (14).

This invention relates to a decoating solution for the wet-chemical removal of a PVD or CVD titanium nitride layer from a hard-metal substrate. The invention also relates to a process for the wet-chemical removal of a PVD or CVD titanium nitride layer from a hard-metal substrate by means of such a decoating solution. Finally, the invention also relates to a device for the wet-chemical removal of a PVD or CVD titanium nitride layer from a hard-metal substrate by such a process.

The decoating process of the type mentioned is used, for instance, in cutting inserts for lathe tools, which often consist of a hard-metal substrate coated with a PVD or CVD titanium nitride layer, to separate the titanium nitride layer from the hard-metal substrate to then route the decoated substrate to a hard-metal treatment.

A suitable process and a matching device for processing hard metal, in particular hard-metal scrap, is known, for instance, from DE 31 44 284 C2 or the post-published DE 10 2020 129 059 (“zinc digestion process”). Hard metal often consists of a carbide hard-material phase (e.g., hard-metal grains or particles arranged in a matrix), which are cohered by means of a metallic binder (e.g., cobalt), for instance after sintering. It is known from the post-published publication to use an inert gas to expel air from a reaction chamber, in which the hard metal to be processed is located, and then to heat zinc material in the reaction chamber such that it liquefies and diffuses into the hard-metal matrix. The zinc material reacts with the binder of the hard metal, significantly increasing its volume and breaking the bond between the carbide hard-material phase and the metallic binder. After evaporation of the zinc material and removal of the zinc vapor from the reaction chamber, the split hard metal can be removed from the reaction chamber and treated or processed further. With regard to the treatment process and the matching device, express reference is made to DE 10 2020 129 059, the entire content of which is intended to form part of the content of this application.

However, in the treatment of hard metal described above, the zinc material used for treating cannot diffuse through a titanium nitride layer into the hard-metal substrate. The treatment described is therefore not suitable for titanium nitride-coated hard metal. This invention is therefore intended to create the prerequisite that a hard metal coated with a PVD or CVD titanium nitride layer, e.g., a cutting insert of a chisel, can also be subjected to such a hard-metal-treatment.

A decoating solution, a decoating process and a decoating device of the type mentioned at the outset are known, for instance, from DE 199 24 589 A1. In this process, the at least one workpiece (indexable insert) is immersed in a decoating solution, which consists of a mixture of oxidizing mineral acids and aqueous solutions of hydrogen halide compounds, or which contains analogous alkaline and/or alkaline earth salts of the mineral acids or hydrogen halide compounds, and which has been acidified to a pH value below 3. Nitric acid or sulphuric acid are used as oxidizing mineral acids. Hydrochloric acid or hydrofluoric acid are used as aqueous solutions of hydrogen halide compounds. DE 199 24 589 A1 mentions mixtures of nitric acid and hydrochloric acid or nitric acid and sulphuric acid and hydrochloric acid or combinations of one of the oxidizing mineral acids, in particular nitric acid and/or sulphuric acid with hydrofluoric acid, as particularly preferred decoating solutions. The problem here, however, is that the known decoating solution contains many different components and acids that are difficult to handle.

Based on the known state of the art, this invention addresses the problem of proposing alternatives for a decoating solution, a decoating process and a decoating device. In particular, this invention is intended to permit a PVD or CVD titanium nitride layer to be removed particularly quickly and efficiently from a hard-metal substrate to be able to then route it to a hard-metal treatment process of the type described above.

To solve this problem, a decoating solution having the features of claim 1 is proposed. In particular, based on the decoating solution of the type mentioned at the outset, proposition is made for the decoating solution to consist of
70-85 wt % of water,
1-10 wt % of a hydrogen compound other than water, and
10-20 wt % of an ammonium salt, and for
   the decoating solution to have a pH value of less than 7 at room temperature.

According to an advantageous further development of the invention, proposition is made for the decoating solution to further contain 1 to 3 wt % of a water-soluble carboxylic acid. The water-soluble carboxylic acid is preferably citric acid.

According to a preferred embodiment of the invention, proposition is made for
the hydrogen compound to be hydrogen peroxide and/or
the ammonium salt to be ammonium bifluoride and/or
the pH value of the decoating solution at room temperature to be less than 5.

The proposed decoating solution can be used to remove a PVD or CVD titanium nitride layer particularly quickly and efficiently from a hard-metal substrate to be able to then route it to a hard-metal treatment process of the type described at the outset.

As a further solution to the problem, a process for the wet-chemical removal of a PVD or CVD titanium nitride layer from a hard-metal substrate by means of a decoating solution having the features of claim 5 is proposed. In particular, based on the decoating process of the type mentioned at the outset, proposition is made for a decoating solution according to the invention to be used, wherein at least one workpiece, consisting of a hard-metal substrate coated with a PVD or CVD titanium nitride layer, is immersed in the decoating solution and therein for a predetermined period of time at temperatures of the decoating solution above room temperature (depending on the standard, this is 20° to 23° C.), for instance at temperatures of above 30° C. Heating the decoating solution to a value above room temperature is particularly conducive to the speed of the decoating process. The at least one workpiece is, for instance, a cutting insert or indexable insert of a chisel, which consists of a substrate made of hard metal coated with a PVD or CVD titanium nitride layer (e.g., tungsten carbide as carbide hard-material phase and cobalt as metallic binder).

According to an advantageous further development of the invention, proposition is made for
the decoating solution to be heated to a temperature of approximately 50° C. before or during swirling of the at least one workpiece therein and/or
a hydrogen compound, which is not water, to be delivered before and/or during the swirling of the at least one workpiece in the decoating solution to maintain the proportion of the hydrogen compound in the decoating solution continuously at 1-10 wt % during decoating.

The supply of the hydrogen compound during the decoating process is particularly beneficial to the efficiency of the decoating process. The hydrogen compound is preferably hydrogen peroxide. It has been shown that particularly fast and efficient decoating can be achieved by heating the decoating solution to approx. 50° C.

According to a preferred embodiment of the invention, proposition is made for a hydrogen compound, in particular hydrogen peroxide, to be delivered during the swirling of the at least one workpiece in the decoating solution to continuously maintain the proportion of the hydrogen compound in the decoating solution at 1-10 wt % during decoating in a processing tank. The metered volume of hydrogen compound added depends on the composition and surface of the PVD or CVD titanium nitride coating of at least one workpiece and on the number of workpieces that are simultaneously immersed in the decoating solution and swirled therein. The decoating process can be accelerated by adding hydrogen. If the decoating solution is depleted of hydrogen, the process slows down and ultimately comes to a standstill.

The speed of the process can thus be influenced by a metered volume of the hydrogen compound delivered and a particularly fast and efficient decoating of the at least one workpiece or its hard-metal substrate can be achieved. The surface of the PVD or CVD titanium nitride coating is defined as the surface that is exposed to the decoating solution to react therewith. The larger the surface area, the more of the hydrogen compound should be delivered. The higher the number of workpieces that are subjected to the decoating process simultaneously, the more of the hydrogen compound should be delivered.

Proposition is made for the metered volume of delivered hydrogen compound, in particular hydrogen peroxide, to be set to 200-500 ml/h for a total volume of the decoating solution in the processing tank of approx. 200 liters.

To be able to perform the decoating process particularly efficiently and quickly, proposition is further made for the at least one workpiece to be filled into a drum, in particular into a screen drum, and for the drum to be at least partially immersed in the decoating solution and rotated therein. As the drum rotates, the workpieces loaded into the drum are swirled in the decoating solution. In addition, the decoating solution is exchanged in the barrel such that no depletion of active (reactive) decoating solution on the surface of the workpieces or the PVD or CVD titanium nitride layers occurs. Another advantage of arranging the workpieces in a drum and rotating them is the associated constant circulation of the workpieces and their friction against each other. In addition, the friction of the hard-metal substrates on the inside of the drum is utilized. All this additionally supports and accelerates the decoating process.

The speed of the drum can vary and is only relevant for the exchange of the decoating solution in the drum and for the frictional effect of the workpieces on each other and/or on the drum. The drum can also be reversed, i.e., the direction of rotation of the drum changes from time to time. The drum is preferably rotated at a speed of around 3 rpm.

Furthermore, proposition is made for the decoated hard-metal substrate of the at least one workpiece to be routed to a hard-metal recycling process after the decoating process has been completed. A suitable hard-metal recycling process is described, for instance, in DE 10 2020 129 059 (so-called “zinc digestion process”), to which explicit reference is made in this regard.

Finally, a device for the wet-chemical removal of a PVD or CVD titanium nitride layer from a hard-metal substrate having the features of claim 12 is proposed as a solution to the problem. In particular, based on the decoating device of the type mentioned at the outset, proposition is made for it to operate according to the process of the invention described above.

According to an advantageous further development of the invention, proposition is made for the device to have a container for holding the decoating solution and a drum, in particular a screen drum, which can rotate in the container, which is designed to receive the at least one workpiece to be decoated and which can be at least partially immersed in the decoating solution and can rotate therein. The drum is preferably rotatable about an axis of rotation that extends in parallel to the surface of the decoating solution. However, the axis of rotation can also extend at an angle to the surface. Preferably, the drum can be immersed in the decoating solution approximately up to its axis of rotation. Particularly preferably, the drum is immersed in the decoating solution to such an extent that all the workpieces in the drum are covered by the decoating solution.

Finally, the drum preferably has the shape of a hollow cylinder having a circular cross-sectional area, wherein the axis of rotation constitutes the cylinder axis. The walls of the drum (cylindrical surface and/or end faces) can be provided with openings to allow the decoating solution to enter the interior of the drum, where the at least one workpiece is located. It is also conceivable that the axis of rotation of the drum is not equal to the cylinder axis, but extends at an angle thereto. Furthermore, the drum does not have to have the shape of a hollow cylinder with a circular base, but can also have any other suitable three-dimensional shape (e.g., hollow cylinder with an elliptical base, cuboid, regular dodecahedron or pentagonal dodecahedron). The at least one workpiece can be filled into the drum via an opening in the drum wall, which can preferably be closed.

According to a preferred embodiment of the invention, proposition is made for the device to comprise a metering unit for the targeted delivery of an adjustable metered volume of a hydrogen compound other than water to the decoating solution during the decoating process. The hydrogen compound is preferably hydrogen peroxide. The hydrogen compound can be taken from a tank or the like.

The metering unit is preferably designed as a metering pump whose rate of delivery can be varied to adjust the metered volume. The rate of delivery can be set once before the decoating process or varied several times during the decoating process. The rate of delivery of the metering unit can be set manually. Preferably, however, the rate of delivery is set automatically depending on certain parameters of the decoating process. In particular, the rate of delivery can be adjusted depending on the composition and dimensions of the surface of the PVD or CVD titanium nitride layer of the at least one workpiece to be decoated. Alternatively or additionally, the rate of delivery can be set depending on the number of workpieces to be decoated at the same time during the decoating process. The number of workpieces in the drum can be determined, for instance, by means of a counter when the workpieces are loaded into the drum or a scale via the weight.

Further features and advantages of the invention are explained in more detail below on the basis of the figures. In the drawings:

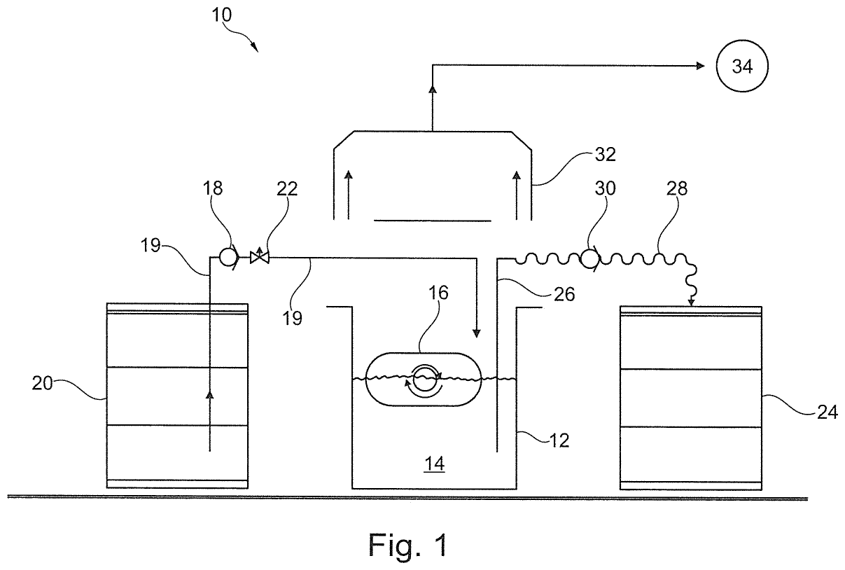

FIG. 1 shows an example of a decoating device according to the invention; and

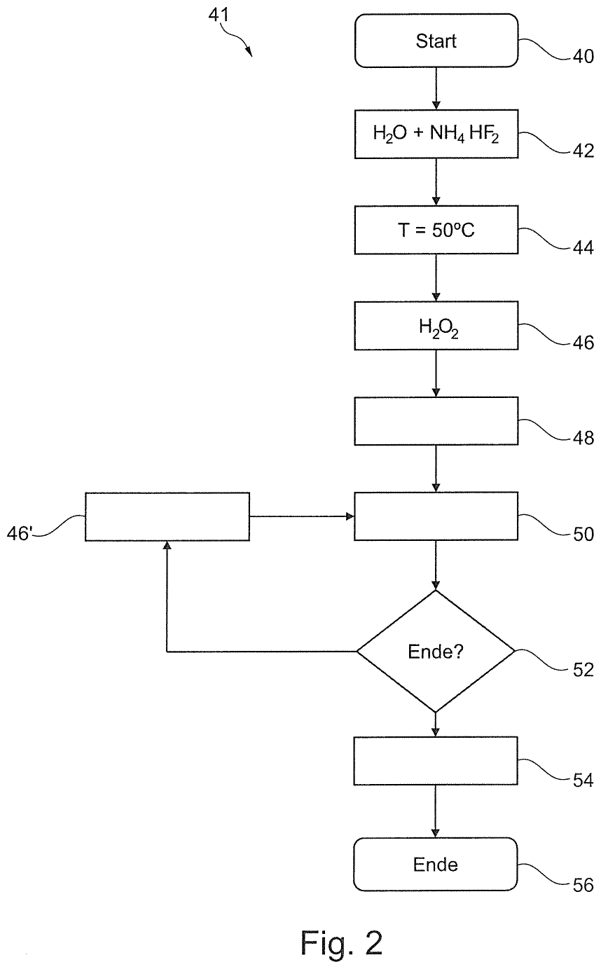

FIG. 2 shows an exemplary flow chart of a decoating process according to the invention.

In FIG. 1, a decoating device according to the invention for the wet-chemical removal of a titanium nitride (TiN) layer from a hard-metal substrate is designated in its entirety by the reference numeral 10. The titanium nitride layer can be applied to the hard-metal substrate using a physical vapor deposition (PVD) or a chemical vapor deposition (CVD) process. As an example of a workpiece consisting of a hard-metal substrate coated with a PVD or CVD titanium nitride layer, reference is made here to a cutting insert, in particular an indexable insert, of a chisel, in particular of a lathe tool for use in a turning tool. Of course, the workpiece, which consists of a hard-metal substrate coated with a PVD or CVD titanium nitride layer, can also be of any other type, but preferably from the tool area, in particular for protection against abrasion or as a cutting metal.

The device 10 operates according to a decoating process 41 according to the invention, which is explained in more detail below with reference to FIG. 2. Such a process is used, for instance, for cutting inserts for chisels to separate the titanium nitride layer from the hard-metal substrate such that the decoated substrate can then be routed to a hard-metal treatment.

A suitable process and a matching device for processing hard metal, in particular hard-metal scrap, is known, for instance, from the post-published DE 10 2020 129 059 (“Zinc digestion process”). Hard metal for use in tools usually consists of a carbide hard-material phase (e.g., hard-metal grains or particles arranged in a matrix, e.g., of tungsten carbide or corundum), which are cohered by means of a metallic binder (e.g., cobalt), e.g., after a sintering process. To treat the carbide, air is expelled from a reaction chamber containing the carbide to be treated using an inert gas, and then zinc material is heated in the reaction chamber such that it liquefies and diffuses into the carbide matrix. The zinc material reacts with the binder of the hard metal, significantly increasing its volume and breaking the bond between the carbide hard-material phase and the metallic binder. After evaporation of the zinc material and removal of the zinc vapor from the reaction chamber, the split carbide can be removed from the reaction chamber and treated or processed further. With regard to the treatment process and the matching device, express reference is made to DE 10 2020 129 059, the entire content of which is intended to form part of the content of this application.

The device 10 comprises a container or processing basin 12 for holding the decoating solution 14 according to the invention, which will be explained in more detail below. The tank 12 has a nominal volume of 200 liters, for instance. Furthermore, the device 10 has a drum 16 that can rotate in the container 12, which is designed in particular as a screen drum. The drum 16 is used to hold at least one workpiece to be decoated. During the decoating process, the drum 16 is at least partially immersed in the decoating solution 14 and can be rotated therein (see arrows in FIG. 1), for instance by means of an electric motor. The drum 16 rotates relatively slowly, e.g., at a speed of around 3 rpm. The drum can be rotated by means of an electric motor.

By rotating the drum 16, the workpieces held therein are swirled in the decoating solution 14. By rotating the drum, the decoating solution 14 in the drum 16 is also exchanged such that no “depletion” of “active” decoating solution 14 occurs on the surface of the workpieces or their titanium nitride layers. A further effect of the rotation of the drum 16 is a friction between an inner wall of the drum 16 and the workpieces or their titanium nitride layers and a friction of the workpieces against each other. All these measures contribute to a particularly fast and efficient decoating of the workpieces and their carbide substrates.

The decoating solution 14 consists of:
70-85 wt % of water, and
10-20 wt % of an ammonium salt.

A metering unit 18, which is designed for instance as a metering pump, is also used to selectively deliver an adjustable metered volume of a hydrogen compound, which is not water, such that the decoating solution 14 contains a proportion of 1-10 wt % of the hydrogen compound. The hydrogen compound is hydrogen peroxide, for instance. The hydrogen compound can also be delivered to the decoating solution 14 in other ways than via the metering unit 18.

The hydrogen compound can be added completely before the decoating process. Preferably, however, the hydrogen compound is added in metered quantities during the decoating process. Surprisingly, it has been shown that this measure requires a particularly small amount of the hydrogen compound.

With a total volume of the decoating solution 14 in the processing tank 12 of approximately 200 liters, the metered volume is, for instance, 200-500 ml/h. The decoating process can be accelerated by adding hydrogen. If the decoating solution 14 is depleted of hydrogen, the process slows down and ultimately comes to a standstill.

In addition, the decoating solution 14 has a pH value of less than 7 at room temperature, preferably less than 5, and is therefore slightly acidic.

The ammonium salt is preferably ammonium bifluoride.

For the decoating process, the decoating solution 14 can be heated to a temperature of approx. 50° C., for instance by means of a heater of the device 10, and kept at this temperature during the decoating process.

In addition, a proportion of 1-3 wt % of a carboxylic acid, e.g., citric acid, can be added to the decoating solution 14 before the start of or during the decoating process.

The metering unit 18 can convey the hydrogen compound, preferably the hydrogen peroxide, from a tank 20, drum or other container via one or more lines 19.

The metered volume of the metering unit 18 can be adjusted, for instance, by changing the speed of a motor-driven metering unit 18.

Alternatively, a proportional valve 22 arranged downstream of the metering unit 18 can be opened to a greater or lesser extent to adjust the metered volume.

The speed of the metering unit 18 or the opening of the valve 22 can be changed manually by an operator or automatically by a control unit. In particular, the metered volume can be set as part of a control system, wherein the concentration of the hydrogen compound in the decoating solution 14 is detected during the decoating process, the metered volume is calculated such that the concentration is 1-10 wt %, and the metering unit 18 or the valve 22 is actuated as a function of the calculated metered volume.

Alternatively or additionally, the metered volume of the metering unit 18 can also be set as a function of time. If it is known for a certain type and number of workpieces or carbide substrates to be decoated how long the decoating process using the decoating solution 14 will take at a temperature of approx. 50° C. with or without citric acid, the metered volume can be reduced to zero after this time has elapsed (possibly plus a time safety buffer) to end the process.

When the decoating process is completed, the decoating solution 14, in which the material of the titanium nitride layers removed from the hard-metal substrates is bound, can be poured or pumped into a waste container 24. This can be done, for instance, by means of a discharge line 26 projecting into the container 12 and opening into the waste container 24 and/or using a matching hose 28 and a pump 30 arranged in the line 26 or the hose 28.

Finally, the device 10 may also comprise an extraction device 32, which extracts gases generated in the container 12 during the decoating process and feeds them, for instance, to a scrubber 34.

The decoating process 41 is explained in more detail below with reference to FIG. 2. The process 41 starts in a function block 40. The ammonium salt, e.g., ammonium bifluoride, is then dissolved in water in a functional block 42 in the container 12. The solution is heated to approx. 50° C. in a function block 44. Once the temperature has been reached, the metering unit 18 adds the hydrogen compound, which is not water, preferably in the form of hydrogen peroxide, into the container 12 in a function block 46 to start the actual decoating process.

The coated carbide workpieces (i.e., substrates with titanium nitride layers) are filled into the drum 16 and immersed in the solution 14 (functional block 48). The drum rotation is activated in a function block 50. An inquiry block 52 checks whether the carbide workpieces have all been completely decoated. The complete decoating of the workpieces can be determined, for instance, by an operator by means of a visual inspection or after a predetermined period of time has elapsed. If this is not the case (“no”), a certain metered volume of the hydrogen compound, which is not water, preferably in the form of hydrogen peroxide, is added to the container 12 again in a function block 46′.

This loop comprising the function blocks 50, 52, 46′ is repeated until the carbide workpieces have all been completely decoated (“yes”). In that case, the addition of the hydrogen compound that is not water, preferably in the form of hydrogen peroxide, is stopped and the decoating process comes to a standstill. In a functional block 54, the decoated carbide workpieces, i.e., the carbide substrates, are removed from the drum 16 and are available for further treatment or processing (e.g., carbide recycling). The process 41 is completed in function block 56.

1-14. (canceled)

15. A decoating solution for wet-chemical removal of a PVD or CVD titanium nitride layer from a hard-metal substrate, the decoating solution comprising:
70-85 wt % of water,
1-10 wt % of a hydrogen compound other than water, and
10-20 wt % of an ammonium salt,
wherein the decoating solution has a pH of less than 7 at room temperature.

16. The decoating solution of claim 15, further comprising 1-3 wt % of a water-soluble carboxylic acid.

17. The decoating solution of 16, wherein the water-soluble carboxylic acid is citric acid.

18. The decoating solution of claim 15, wherein the hydrogen compound is hydrogen peroxide.

19. The decoating solution of claim 15, wherein the ammonium salt is ammonium bifluoride.

20. The decoating solution of claim 15, wherein the pH of the decoating solution at room temperature is less than 5.

21. A decoating method of wet-chemical removal of a PVD or CVD titanium nitride layer from a hard-metal substrate comprising:
a step of immersing a workpiece, comprising a hard-metal substrate coated with a PVD or CVD titanium nitride layer, in a solution comprising water and an ammonium salt;
a step of delivering a hydrogen compound other than water to the solution to form a decoating solution comprising (i) 70-85 wt % of water; (ii) 1-10 wt % of a hydrogen compound other than water, and (iii) 10-20 wt % of an ammonium salt, and having a pH of less than 7 at room temperature; and
a step of swirling the workpiece in the decoating solution for a predetermined period of time;
wherein the decoating solution has a temperature above room temperature during the step of swirling the workpiece in the decoating solution.

22. The decoating method claim 21, wherein the decoating solution is heated to a temperature of approx. 50° C. during the step of swirling the workpiece in the decoating solution.

23. The decoating method of claim 21, wherein the hydrogen compound is delivered during the step of swirling the workpiece in the decoating solution, such that a proportion of the hydrogen compound in the decoating solution is maintained at a range of 1-10 wt %.

24. The decoating method of claim 21, wherein the step of delivering the hydrogen compound occurs before the step of immersing the workpiece.

25. The decoating method of claim 21, wherein the hydrogen compound is hydrogen peroxide

26. The decoating method of claim 21, wherein a metered volume of hydrogen compound supplied depends on a composition and surface of the PVD or CVD titanium nitride layer of the workpiece or on a number of workpieces which are simultaneously immersed in the decoating solution.

27. The decoating method of claim 26, wherein the metered volume of hydrogen compound delivered ranges from 200-500 ml/h per approximately 200 liters of the decoating solution.

28. The decoating method of claim 21, further comprising a step wherein the workpiece is placed into a drum and the step of immersing the workpiece comprises at least partially immersing the drum in the solution, and wherein the step of swirling the workpiece comprises rotating the drum therein.

29. The decoating method of claim 28, wherein the drum is a screen drum.

30. The decoating method of claim 28, wherein the drum is rotated at a speed of approximately 3 rpm.

31. The decoating of claim 21, further comprising a step of routing the decoated hard-metal substrate of the workpiece to a hard-metal recycling process after decoating.

32. A decoating device for the wet-chemical removal of a PVD or CVD titanium nitride layer from a hard-metal substrate by the decoating method of claim 21.

33. A decoating device for the wet-chemical removal of a PVD or CVD titanium nitride layer from a hard-metal substrate, comprising:
a container for holding a decoating solution comprising (i) 70-85 wt % of water; (ii) 1-10 wt % of a hydrogen compound other than water, and (iii) 10-20 wt % of an ammonium salt, and having a pH of less than 7 at room temperature; and
a drum, configured to receive a workpiece and to rotate in the container (12),
wherein the drum is configured to be at least partially immersed in the decoating solution and rotated therein.

34. The decoating device of claim 33, further comprising a metering unit for targeted delivery of an adjustable metered volume of a hydrogen compound to the decoating solution during decoating.
